(19) United States
(12) Patent Application Publication
(10) Pub. No.: US 2010/0135707 A1
(43) Pub. Date: Jun. 3, 2010

(54) SCANNER PAGE ALIGNMENT TOOLS

(75) Inventor: Lee Coy Moore, Penfield, NY (US)

Correspondence Address: JAMES J. RALABATE, 5792 MAIN ST., WILLIAMSVILLE, NY, 14221, US

(73) Assignee: XEROX CORPORATION, NORWALK, CT (US)

(21) Appl. No.: 12/697,487

(22) Filed: Feb. 1, 2010

Related U.S. Application Data
(63) Continuation-in-part of application No. 11/514,276, filed on Sep. 1, 2006.

(51) Int. Cl. G03G 15/00

(52) U.S. Cl. 399/379

(57) ABSTRACT

This is a system to provide real time ways of aligning a paper original with a skewed image so that a right imaged reproduction is produced on subsequent copies. Alignment members used in the method of this invention are at least two members of: (A) flood lamps positioned above and below a platen, (B) alignment marks on the platen, and (C) a video camera.

This is a Continuation In Part application of parent application Ser. No. 11/514,276, filed in the U.S. Patent and Trademark Office on Sep. 1, 2006.

This invention relates to electrostatic marking systems and, more specifically, to scanner components and paper aligning techniques of these systems.

### BACKGROUND

In electrostatographic process, a system is used whereby a uniform electrostatic charge is placed upon a reusable photoconductive surface. The charged photoconductive surface is then exposed to a light image of a scanned original document to selectively dissipate the charge to form a latent electrostatic image of this original on the photoreceptor. The latent image is developed by depositing finely divided marking and charged particles (toner) upon the photoreceptor surface. The charged toner is electrostatically attached to the latent electrostatic image areas to create a visible replica of the original. The toned developed image is then transferred from the photoconductor surface to a final image support material, such as paper, and the toner image is fixed thereto by heat and pressure to form a permanent copy corresponding to the original.

In Xerographic systems of this type, a photoreceptor surface is generally arranged to move in an endless path through the various processing stations of the Xerographic process. The photoconductive or photoreceptor surface is generally reusable whereby the toner image is transferred to the final support material, and the surface of the photoreceptor is prepared to be used once again for another reproduction of an original scanned document.

Several methods are known for applying an electrostatic charge to the photosensitive member such as the use of electron-emitting pins, an electron-emitting grid, single corona-charging structures and single or multiple dicorotron wire assemblies. In recent development of high speed Xerographic reproduction machines where copiers can produce at a rate of or in excess of three thousand copies per hour, the need for reliable scanning techniques and properly aligned final copies are required.

Usually, in electrostatographic or electrostatic copy processes, as those above noted, an original document is placed upon a platen glass and scanned whereby the scanned image is transferred to the photoconductor surface. It is difficult to align paper documents on a multi-function scanner platen because the paper is placed face down and thus not directly viewable by a user. Sometimes multi-generation originals will have badly skewed printed images so that aligning the paper to the edges of the scanner will not have the desired result. In such cases, multiple copies must be made until the image on the paper has the correct alignment that is squared with the paper.

### SUMMARY OF THE INVENTION

The various embodiments of the present invention provide a system, process and apparatus whereby proper alignment of an image on an original document is effectively achieved.

Some original paper documents have images on them that are not quite square with the paper. Some scanners do not scan all the way to the edge of the paper (not full bleed). This leads to causes where the user wants to have the best image but (face down) scanning technologies that are used in multifunction devices lead to multiple scans and prints being made.

It would be desirable to have a real-time way of aligning the paper so that the “right” image is produced.

There are several approaches in and combinations of the present invention that one could take based on cost and ease of use. They are: A. flood lamps from above and below to illuminate the paper enough to show a back lit image. This would provide a rough guide for single sheets of paper; B. Alignment marks could be painted with rotating laser beams from below and/or above. This would provide a grid for aligning to; also, C. a low cost camera could be put in the scanner well and the image from it would be displayed as a real time video image on the multi-function's user interface. These could be used in combination, all of A, B, and C, with each other or with a combination of any two alignment members A, B, and C in a method or process for proper alignment of an image.

There is provided in the present embodiments ways for making a scanner easier to use when alignment becomes critical. This could be a useful productivity tool and a product differentiator.

This invention, as above noted, proposes any combination of three methods to align an image that is skewed with respect to the edge of the substrate so the resulting scan is aligned with the edges of the image: (1) Internal floodlights that illuminate for the image alignment phase, from above and below the platen, would let the operator view the material to be scanned through the back of the substrate; (2) Alignment marks could be projected onto the substrate with a laser or other device; and (3) A simple video camera could be added to provide a real time preview image so the original can be rotated into position.

### BRIEF DESCRIPTION OF THE DRAWINGS

FIG. 1 is an illustration of an imaged substrate where the text of the image needs to be better aligned.

FIG. 2 illustrates a side view of an embodiment where a floodlight or lights illuminates the imaged paper or substrate from above and underneath.

FIG. 3 illustrates a top view of an embodiment where alignment marks are projected onto the back of the substrate.

FIG. 4 illustrates a side view of an embodiment where a simple video camera is used together with floodlights and/or alignment marks to provide real time preview image.

### DETAILED DISCUSSION OF DRAWINGS AND PREFERRED EMBODIMENTS

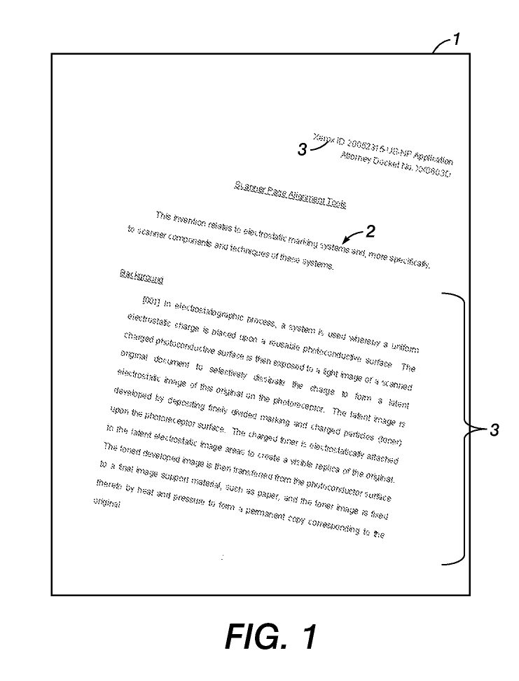

In FIG. 1 an imaged paper page 1 has an image or marking 2 that is badly skewed (as shown at 3) and not squared with the paper 1. As new generations of copies of page 1 are made, progressively misaligned images 2 frequently occur, more pronounced as new generations are made from badly skewed originals. The embodiments herein described provide ways of making proper alignment of skewed image 3.

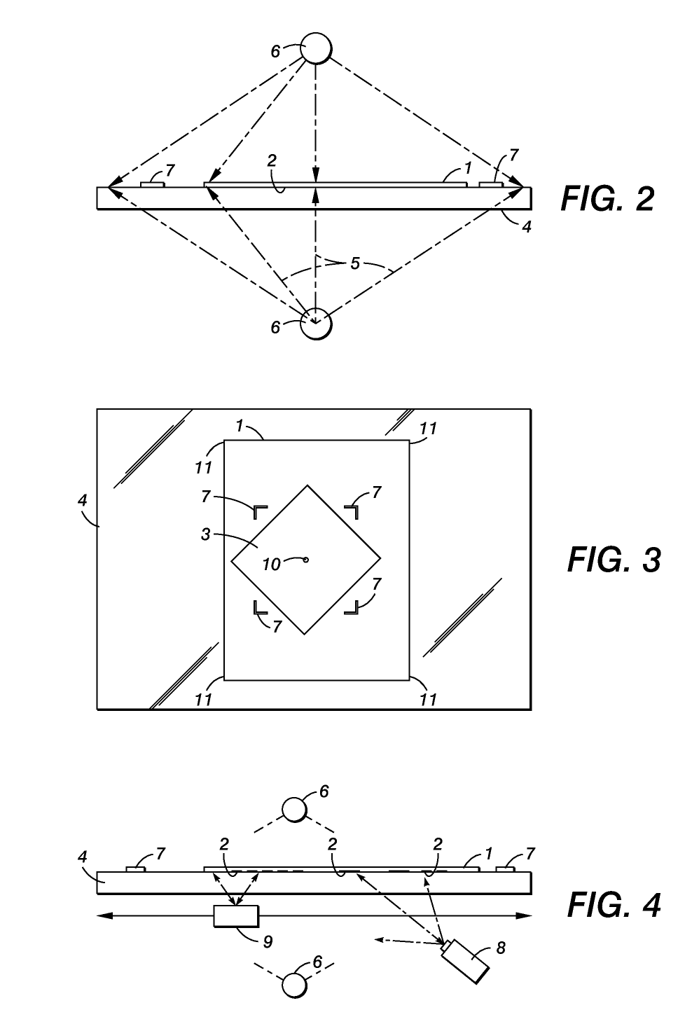

One embodiment for providing a proper alignment is shown in side view of FIG. 2 where a floodlight or lights 6 (or other suitable lighting means) are used with light rays 5 to illuminate at the same time as shown the platen glass 4 with alignment marks and original paper 1 from both above and below at the same time enough to show a backlit image. The paper 1 is placed image face down on platen 4. This backlit image 2 or skewed image 3 will provide a rough guide for single sheets of paper 1 having an image 2 out of alignment. The paper 1 merely needs to be adjusted on platen 4 until a properly squared image 2 is obtained to be transferred to the next copy made. The floodlight 6 may be positioned in a well below the platen glass 4 or in any other suitable location. Corner-to-corner markings 7 are used in this embodiment with the floodlights 6 as alignment.

In FIG. 3, a top view of a platen 4 is shown as it supports an original paper 1. The misaligned original of FIG. 1 merely needs to be rotated or moved so that skewed image 3 (not paper) is now squared within corner-to-corner markings 7 so that copies of images 2 made from this original 1 will be squared with the paper 1. The alignment marks 7 can be painted with rotating lasers from below or above platen 4. These corner-to-corner alignment marks 7 can be projected onto the paper substrate 1 or onto the platen 4. Again, paper 1 is placed upon platen 4 with the imaged surface 2 of paper 1 face down. These marks 4 provide without obstruction a corner-to-corner grid for aligning the skewed image 3. Also, the misaligned copy of FIG. 1 in another embodiment is fit within squared markings 7 so that each corner of the copy fits within the area outlined by the markings 7. The copy within markings 7 is then rotated along axis 10 until the text of the copy is even vertically and horizontally (using platen corners 11 as a gauge). The misaligned copy is now perfectly squared and can be copied in proper alignment. Paper 1 is not drawn to scale for clarity of description of this embodiment. The alignment marks 7 are used in one embodiment together with the illumination with flood lamps 6 from above and below the platen 4.

In FIG. 4, a side view of an embodiment is illustrated where a camera 8 (such as a low cost camera) is placed above the paper 1 or in the scanner means 9. At least one alignment marks 7 and floodlights 6 may also be used in this embodiment. The simple video camera 8 can be added to provide a real time preview image 2 so the original 1 can be rotated in position. The camera 8 could be put in the scanner 9 well and the image from it would be displayed in real time video on the multi-function's user interface.

In summary, this invention provides in an embodiment, a paper alignment method for use in a xerographic process which comprises providing a platen glass in an image exposure station, providing alignment members selected from the group consisting of corner-to-corner alignment marks on the platen and flood lamps or lights positioned above and below the platen. Flood lamps were provided that are configured to illuminate an original document and the platen when using the substrate alignment marks both from below and above the platen sufficient to show a back lit image on the original document placed on the platen.

The alignment members are configured to align the document and permit a proper copying alignment of the image on the original document to be transferred to and reproduced on a receiving surface, and thereby provide an image that is squared with the original document. The flood lamps are positioned above and below the platen glass and are configured with the alignment marks and in one embodiment also the video camera to align the original document that is placed upon the platen glass. The alignment marks on the platen provide an open grid configured to align the document. The flood lamps are configured to illuminate the platen glass from both above and below the platen glass during scanning of the platen glass and the original document.

In summary, the present embodiments provide an electrostatic copy system comprising an image exposure station. This image exposure station comprises in an operative arrangement a method using a platen glass together with at least two members selected from the group consisting of flood lamp(s), a camera(s) and paper or corner-to-corner substrate alignment marks. In this alignment method, the flood lamp(s) are positioned above and below said platen glass and are enabled to illuminate a paper placed face down upon said platen glass. Also, the corner-to-corner alignment marks are projected upon the platen glass to provide thereby a grid for easily aligning the paper. Further, a camera is positioned in a scanner well; this camera is enabled to project an image displayed in a real time video image on a multifunction user interface. When the floodlight is used with one of the other alignment members, the floodlight is enabled to allow an operator to view an image through a clear platen and on the paper through the back of the paper or substrate. The present electrostatic copy system as noted comprises an image exposure station adapted to process an imaged substrate or paper. This image exposure station comprises in an operative arrangement a platen glass unit together with at least two paper alignment members selected from the group consisting of above platen and below platen flood lamp(s), a video camera(s), and corner-to-corner substrate alignment marks. The platen glass unit is adapted to support and scan the imaged paper. The substrate alignment members are configured to align the imaged paper to provide an image thereon that is squared with the paper. Also, these alignment members are enabled to permit the scanner operator to know where which areas of the platen glass are not scanned so that a full and complete image can be reproduced. The flood lamp(s) are positioned above and below the platen glass and are configured to illuminate the paper that is placed image face down upon the transparent or clear platen glass. The alignment marks are laser projected upon the platen glass to provide thereby a corner-to-corner grid for aligning the imaged paper with grid marks in the center to interface with the image.

The preferred and optimally preferred embodiments of the present invention have been described herein and shown in the accompanying drawings to illustrate the underlying principles of the invention, but it is to be understood that numerous modifications and ramifications may be made without departing from the spirit and scope of this invention.

What is claimed is:

1. A method of aligning an image placed in an exposure station of an electrostatic copy system, said method comprising:
providing a platen glass in said exposure station, placing face down on said platen an original paper or document to be transferred to and reproduced on a receiving surface of said electrostatic copy system,
using at least two alignment members selected from the group consisting of lights or flood lamps above and below said platen, alignment marks on said platen and a video camera,
illuminating said platen, both from below and above said platen sufficient to show a back lit image, and
providing said back lit image to be viewed by an operator through a back of said paper, and
realigning said back lit image so that it is in proper image alignment squared with said paper.

2. The method of claim 1 wherein said alignment members used are said flood lights and said alignment marks.

3. The method of claim 1 wherein said alignment members used are said flood lights and said video camera.

4. The method of claim 1 wherein said aligned members used are said flood lights, said video camera, and said alignment marks.

5. The method of claim 1 wherein said alignment marks are corner-to-corner marks.

6. A method of providing an aligning image in an exposure station of an electrostatic copy system, said method comprising:
providing a platen glass in said exposure station, placing face down on said platen an original paper or document to be transferred to and reproduced on a receiving surface of said electrostatic copy system,
placing an alignment member in said exposure station, said alignment member comprising at least two members selected from the group consisting of alignment marks on said platen glass, flood lamps above and below said platen and a video camera,
scanning and illuminating said platen, both from below and above said platen sufficient to show a back lit image,
providing said back lit image to be viewed by an operator through a back of said paper, and providing said at least two alignment members that are configured to align an image on said original document to obtain an image thereon squared with said paper.

7. The method of claim 6 wherein said alignment marks and said flood lamps are used as the alignment members.

8. The method of claim 6 wherein said alignment marks and said video camera are used as the alignment members.

9. The method of claim 6 wherein said video camera and said flood lamps are used as the alignment members.

10. The method of claim 6 wherein said alignment marks, said flood lamps, and said video camera are all used as the alignment members.

11. The method of claim 6 wherein said alignment marks are corner-to-corner marks.

12. An electrostatic copy method comprising:
providing a platen glass in an image exposure station of an electrostatic copier apparatus,
providing in said image exposure station substrate alignment members, said substrate alignment members comprising a video camera, flood lamps and substrate alignment marks on said platen glass,
providing said flood lamps, one positioned above said platen glass and one positioned below said platen glass,
placing an imaged substrate face down on said platen glass, and during scanning of said platen glass and said imaged substrate, illuminating said platen glass and said imaged substrate from both above and below said platen glass, and
using at least two of said substrate alignment members to align said imaged substrate to provide thereby an image thereon squared with said paper.

13. The method of claim 12 wherein an image on said imaged substrate is viewed by an operator through a back of said imaged substrate.

14. A paper alignment method of claim 12 useful in an electrostatic copy system comprising said method providing an image exposure station, said image exposure station comprising:
a platen glass in said image exposure station, providing alignment members selected from the group consisting of alignment marks on said platen and flood lamps or lights positioned above and below said platen,
said flood lamps configured to illuminate an original document and said platen with corner-to-corner substrate alignment marks, said flood lamps used both from below and above said platen sufficient to show a back lit image on said original document placed on said platen,
wherein said alignment members are configured to align said document and permit a proper copying alignment of said image on said original document to be transferred to and reproduced on a receiving surface, and provide an image that is squared with said original document,
said flood lamps that are positioned above and below said platen glass are configured with said alignment marks to align said original document that is placed upon said platen glass, said alignment marks on said platen providing a grid configured to align said document,
said flood lamps configured to illuminate said platen glass from both above and below the platen glass during scanning of said platen glass and said original document.
